(19) United States
(12) Patent Application Publication
(10) Pub. No.: US 2026/0177504 A1
(43) Pub. Date: Jun. 25, 2026

(54) O-RING APPEARANCE INSPECTION APPARATUS AND O-RING APPEARANCE INSPECTION METHOD

(71) Applicant: DAIICHI JITSUGYO VISWILL CO., LTD., Osaka (JP)

(72) Inventor: Koji MATSUI, Osaka (JP)

(73) Assignee: DAIICHI JITSUGYO VISWILL CO., LTD., Osaka (JP)

(21) Appl. No.: 19/425,598

(22) Filed: Dec. 18, 2025

(30) Foreign Application Priority Data
Dec. 19, 2024 (JP) 2024-224545

(51) Int. Cl. G01N 21/892; G01N 21/01; G01N 21/95

(52) U.S. Cl. CPC G01N 21/892; G01N 21/01; G01N 21/95; G01N 2021/0112; G01N 2021/8924

(57) ABSTRACT

An O-ring appearance inspection apparatus of the present invention includes a holding device having a head unit and a tack surface body having physical tackiness, which is provided on the head unit; and a camera configured to image-capture the O-ring K. The O-ring K is held by bringing the mounting surface on which the O-ring K is placed closer to the head unit, thereby pressing the O-ring K against the tack surface body and bringing the O-ring K into tight contact with the tack surface body. The O-ring K, being held, is moved to the image-capturing position P, and the O-ring K is image-captured by rotating the head unit about the rotation axis C1 at the image-capturing position P.

### TECHNICAL FIELD

The present invention relates to an apparatus and a method for appearance inspection of an O-ring.

### BACKGROUND ART

Traditionally, O-rings have been used for parts of various devices to be sealed. In recent years, O-rings are sometimes required to have higher airtightness, and for that purpose, O-rings (mirror-finished O-rings) having mirror-finished surfaces with small surface roughness have been provided. Further, since such mirror-finished O-rings are required to have high sealing performance, even shallow dents or scratches cause quality problems. Therefore, in recent years, there has been a demand for an appearance inspection apparatus capable of detecting extremely shallow dents, scratches, and scuffs on the surfaces of such mirror-finished O-rings.

Patent Document 1 discloses an appearance inspection apparatus capable of detecting defects such as shallow dents and scratches on the surfaces of such mirror-finished O-rings. In the appearance inspection apparatus disclosed in Patent Document 1, illumination light is emitted toward the O-ring, and the O-ring is image-captured from the same direction as the direction of the illumination light. In the appearance inspection apparatus disclosed in Patent Document 1, most of the illumination light is specularly reflected when the surface of the O-ring is normal. However, when a defective portion such as a dent or a scratch exists on the surface of the O-ring, the illumination light is diffusely reflected at the defective portion, and the reflected light does not enter the line sensor camera. Thus, the appearance inspection apparatus of Patent Document 1 can detect defects such as shallow dents and scratches on the surfaces of mirror-finished O-rings.

### PRIOR ART DOCUMENTS

### Patent Documents

[Patent Document 1] Japanese Patent Application Laid-Open No. 2024-40819

### SUMMARY OF THE INVENTION

### Problem to be Solved

O-rings used in portions requiring airtightness, such as semiconductor manufacturing apparatuses, are subject to strict inspection requirements, and even very minor scratches or scuffs are regarded as defects. Further, O-rings having mirror-like glossy surfaces to enhance airtightness can significantly impair the required airtightness even when very minor scratches or scuffs occur on their surfaces. Therefore, in the appearance inspection of O-rings, it is required to perform the inspection while suppressing deformation, scratches, and adhesion of foreign matter caused when holding the O-rings during the appearance inspection. Further, since there are slight individual differences among O-rings, misalignment of the rotation axis position when rotating the O-ring in front of the camera for image-capturing causes inspection defects. Furthermore, as a prerequisite, it is necessary to avoid situations in which the inspection process becomes complicated or the inspection time becomes prolonged in order to address these issues. In other words, these issues must be addressed while ensuring inspection efficiency.

In view of the above points, an object of the present invention is to provide an O-ring appearance inspection apparatus and an O-ring appearance inspection method that are capable of holding an O-ring at an accurate rotation axis position regardless of individual differences, while suppressing deformation, scratches, and adhesion of foreign matter, thereby enhancing the accuracy and efficiency of appearance inspection.

### Solution to Problem

The inventors of this application considered various methods for a configuration to hold the O-ring. Here, if the O-ring is held by using an adhesive, the O-ring can be reliably held; however, there is a risk that adhesive residue (so-called glue residue) may occur on the O-ring, leading to defects. Therefore, the inventors of this application considered configurations in which, for example, a recessed portion or a protrusion that can receive the O-ring is provided at the distal end (head unit) of a robot arm to fit the O-ring therein, or a suction port is provided in the head unit to hold the O-ring by suction. However, in the configuration in which the O-ring is held by a recess/protrusion or a suction port, even small individual differences in the O-ring cause misalignment with respect to the recess/protrusion or the suction port, making it difficult to reliably hold the O-ring. Further, during appearance inspection of the O-ring, the head unit is oriented downward immediately after holding the O-ring. Therefore, in a configuration in which the O-ring is fitted into a recess or protrusion, the size must be set as a tight tolerance size that accounts for individual differences of the O-ring in order to ensure reliable holding, which may cause deformation. Additionally, if the O-ring is to be held solely by the suction force of the suction port, there is a risk that the O-ring may fall when the suction port is misaligned with the contact surface and the head unit is facing downward or obliquely.

To solve these issues, it is also conceivable to adopt a member or mechanism configured such that the contact surface area or the distribution area of contact points with the O-ring becomes wide when holding the O-ring, so as to disperse or suppress the force applied to the O-ring while holding it. However, if the contact surface area or the distribution area of contact points of the member or mechanism with respect to the O-ring becomes wide, the area of the O-ring covered by the member or mechanism also increases. As the area of the O-ring covered by the member or mechanism increases, the exposed area of the O-ring decreases, making it difficult to perform appearance inspection of the O-ring. Therefore, it is also required to hold the O-ring while securing the exposed area of the O-ring by a simple method.

As a result of further consideration, it was found that, by providing a tack surface body having physical tackiness at the distal end (head unit) of the holding device and holding the O-ring by pressing the tack surface body to bring the O-ring into tight contact, the O-ring can be held at an accurate position while ensuring a large exposed area regardless of individual differences of the O-ring, by a simple method.
(1) An O-ring appearance inspection apparatus of the present invention provided based on the above findings is an O-ring appearance inspection apparatus that performs appearance inspection on an O-ring, including: a holding device having a head unit rotatable about an rotation axis and a tack surface body having physical tackiness, which is provided on the head unit, the holding device configured to hold the O-ring and rotate it in a circumferential direction; and a camera configured to image-capture the O-ring. The O-ring is held by bringing the head unit and a mounting part on which the O-ring is placed closer to each other, thereby pressing the O-ring against the tack surface body and bringing the O-ring into tight contact with the tack surface body, the O-ring, being held, is moved to an image-capturing position facing the camera, and the O-ring is image-captured by the camera while being rotated in its circumferential direction by rotating the head unit about its rotation axis at the image-capturing position.

According to the O-ring appearance inspection apparatus of (1), the O-ring can be held by bringing it into tight contact with the tack surface body through a simple operation of pressing the O-ring against the mounting part, thereby keeping the O-ring from being deformed, scratched, or having foreign matter adhered thereto. In other words, the O-ring appearance inspection apparatus of (1) can hold the O-ring while suppressing a mechanical load applied to the O-ring. Further, in the O-ring appearance inspection apparatus of (1), since the O-ring is held by the physical tackiness of the tack surface body, the holding state of the O-ring can be maintained even when the posture of the O-ring changes.

Further, since the tack surface body can hold the O-ring by contacting only a portion of one half toroidal portion of the O-ring in the rotation axis direction, a larger exposed area of the O-ring can be secured. Further, the camera is configured to image-capture at least the other side (exposed side) different from the one half toroidal portion (contact side) including the portion of the O-ring that is in contact with the tack surface body. Therefore, the O-ring appearance inspection apparatus ensures a large area of the O-ring image-captured by the camera, enabling efficient image-capturing. Thus, according to the O-ring appearance inspection apparatus of (1), by simple means, it is possible to hold the O-ring at an accurate position while ensuring a large exposed area regardless of individual differences of the O-ring, thereby suppressing misalignment of an image-capturing target position when the O-ring is rotated in the circumferential direction at the image-capturing position and improving the accuracy and efficiency of the appearance inspection. As a result, the O-ring appearance inspection apparatus of (1) can further suppress deformation or scratches of the O-ring and improve the accuracy and efficiency of the appearance inspection.
(2) The O-ring appearance inspection apparatus of the present invention may be the O-ring appearance inspection apparatus of the above (1) such that the holding device is configured to hold the O-ring while maintaining the shape of the O-ring and the relative position with respect to the head unit, by allowing the tack surface body to elastically deform so that it is in tight contact with the O-ring.

In the O-ring appearance inspection apparatus of (2), the tack surface body can hold the O-ring by undergoing elastic deformation, without causing deformation of the O-ring. In other words, the O-ring appearance inspection apparatus of (2) can hold the O-ring while suppressing a mechanical load applied to the O-ring. Further, in the O-ring appearance inspection apparatus of (2), since the O-ring is held by the physical tackiness of the tack surface body, the O-ring can be held while maintaining its relative position to the head unit even when the posture of the head unit changes. As a result, according to the O-ring appearance inspection apparatus of (2), it is possible to suppress the occurrence of deformation or scratches of the O-ring, as well as to suppress the positional misalignment of the O-ring during rotation, thereby further improving the accuracy and efficiency of the appearance inspection.
(3) The O-ring appearance inspection apparatus of the present invention may be the O-ring appearance inspection apparatus of the above (1) or (2) such that the tack surface body contains, as a main component, at least one resin selected from among a silicone-based resin, an acrylic-based resin, and a rubber-based adhesive resin.

According to the O-ring appearance inspection apparatus of (3), the tack surface body having high flexibility can be brough into tight contact with the O-ring. Therefore, the O-ring appearance inspection apparatus of (3) can more reliably hold the O-ring while suppressing the occurrence of deformation or scratches, and improve the accuracy and efficiency of the appearance inspection.
(4) The O-ring appearance inspection apparatus of the present invention may be the O-ring appearance inspection apparatus of any of the above (1) to (3) such that the holding device holds the O-ring by the tackiness of the tack surface body in a state where the head unit is oriented obliquely or downward during at least portion of the operations including the movement operation to the image-capturing position of the O-ring and the rotation operation of the head unit.

According to the O-ring appearance inspection apparatus of (4), the O-ring can be held by the tackiness of the tack surface body even when the head unit is in a posture, such as an obliquely downward or downward posture, that raises concerns about dropping or positional deviation of the O-ring during appearance inspection of the O-ring. This enables suppression of the load applied to the O-ring and also suppression of dropping or positional misalignment of the O-ring. Therefore, according to the O-ring appearance inspection apparatus of (4), a decrease in inspection efficiency caused by the O-ring falling can be suppressed. As a result, the O-ring appearance inspection apparatus of (4) can suppress the occurrence of deformation or scratches of the O-ring, improve the accuracy of the appearance inspection, and also suppress the decrease in inspection efficiency.
(5) The O-ring appearance inspection apparatus of the present invention may be the O-ring appearance inspection apparatus of any of the above (1) to (4) such that the holding device includes a negative pressure chamber in which a negative pressure is generated, and a through hole provided in the tack surface body and in communication with the negative pressure chamber; and removes the O-ring that is in tight contact with the tack surface body by discharging air from the negative pressure chamber via the through hole.

According to the O-ring appearance inspection apparatus (5), the O-ring can be removed from the holding device without applying a load to the surface of the O-ring, thereby further suppressing deformation or scratches of the O-ring. As a result, the O-ring appearance inspection apparatus of (5) can further suppress deformation or scratches of the O-ring and improve the accuracy and efficiency of the appearance inspection.
(6) An O-ring appearance inspection method of the present invention is an O-ring appearance inspection method using an O-ring appearance inspection apparatus comprising a holding device configured to hold an O-ring and a camera configured to image-capture the O-ring. The holding device comprises a head unit rotatable about its rotation axis and a tack surface body having physical tackiness, which is provided on the head unit. The O-ring is held by bringing the head unit and a mounting part on which the O-ring is placed closer to each other, thereby pressing the O-ring against the tack surface body and bringing the O-ring into tight contact with the tack surface body (holding step), the O-ring, being held, is moved to an image-capturing position facing the camera (moving step), and the O-ring is image-captured by the camera while being rotated in its circumferential direction by rotating the head unit about its rotation axis at the image-capturing position (image-capturing step).

According to the O-ring appearance inspection method of (6), the O-ring can be held by bringing it into tight contact with the tack surface body through a simple operation of pressing the O-ring against the mounting surface, thereby keeping the O-ring from being deformed, scratched, or having foreign matter adhered thereto. In other words, the O-ring appearance inspection method of (6) can hold the O-ring while suppressing a mechanical load applied to the O-ring. Further, in the O-ring appearance inspection method of (6), since the O-ring is held by the physical tackiness of the tack surface body, the holding state of the O-ring can be maintained even when the posture of the O-ring changes.

Further, the tack surface body can hold the O-ring by contacting only a portion of one half toroidal portion of the O-ring in the central axis direction. The camera is configured to image-capture at least the other side (exposed side) different from the one half toroidal portion (contact side) including the portion of the O-ring that is in contact with the tack surface body, thereby ensuring a large exposed area of the O-ring and enabling efficient image-capturing. Thus, according to the O-ring appearance inspection method of (6), the O-ring can be held at an accurate position while ensuring a large exposed area regardless of individual differences of the O-ring, thereby suppressing misalignment of an image-capturing target position when the O-ring is rotated in the circumferential direction at the image-capturing position and improving the accuracy and efficiency of the appearance inspection. As a result, the O-ring appearance inspection method of (6) can further suppress variation or scratches of the O-ring and improve the accuracy and efficiency of the appearance inspection.

### Advantageous Effect of the Invention

According to the present invention, it is possible to provide an O-ring appearance inspection apparatus and an O-ring appearance inspection method that can hold an O-ring at an accurate axis position while suppressing deformation, scratches, and adhesion of foreign matter, thereby enhancing the accuracy and efficiency of appearance inspection regardless of individual differences.

### BRIEF DESCRIPTION OF THE DRAWINGS

FIG. 1 is a schematic diagram showing an entire O-ring appearance inspection apparatus according to an embodiment of the present invention.

FIG. 2 is a diagram showing an example of an O-ring that is an inspection target of the O-ring appearance inspection apparatus of FIG. 1. (a) is a plan view, (b) is a cross-sectional view taken along the A1-A1 section line in FIG. 2(a), and (c) is a cross-sectional view showing a state in which the O-ring is in tight contact with a tack surface body.

FIG. 3 is an exploded perspective view showing a head unit of the O-ring appearance inspection apparatus of FIG. 1.

FIG. 4 is a diagram showing the positions of the cameras and the illumination device of the O-ring appearance inspection apparatus of FIG. 1. (a) is a front view, (b) is a plan view, (c) is a partial enlarged view showing a first illumination light in a plan view, and (d) is a partial enlarged view showing a first illumination light in a front view.

FIG. 5 is a perspective view showing the camera optical axis, illumination light, and an inspection target portion of the O-ring appearance inspection apparatus of FIG. 1.

FIG. 6 is a diagram showing the operation of the O-ring appearance inspection apparatus of FIG. 1.

FIG. 7 is a diagram showing the operation of the O-ring appearance inspection apparatus holding the O-ring of FIG. 1.

FIG. 8 is a front view showing the relative angles of the O-ring appearance inspection apparatus of FIG. 1.

FIG. 9 is a diagram showing the inspection target portions and images as image-capturing results at each relative angle of the O-ring appearance inspection apparatus of FIG. 1.

### DESCRIPTION OF EMBODIMENTS

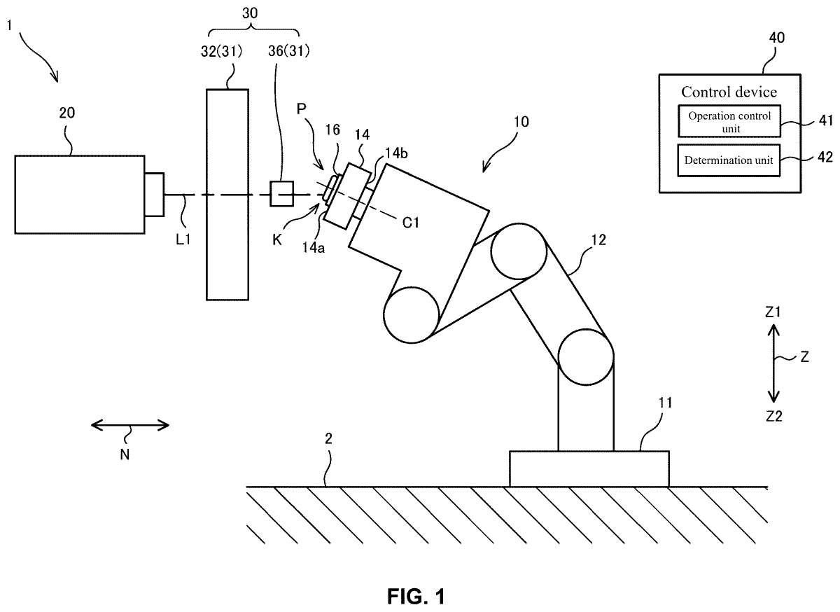

Embodiments of the present invention will be described below with reference to the drawings. FIG. 1 is a schematic diagram showing an entire O-ring appearance inspection apparatus 1 according to an embodiment of the present invention. The O-ring appearance inspection apparatus 1 is configured to perform an appearance inspection of an O-ring K. Specifically, the O-ring appearance inspection apparatus 1 is used for performing an inspection for the presence or absence of scratches, deformation, and foreign matter adhering to the surface of the O-ring K (appearance inspection).

The O-ring K is, for example, a component for sealing a fluid such as a gas or a liquid. The O-ring K is used in a variety of fields, including automobiles, hydraulic and pneumatic equipment, household electrical appliances, and semiconductor equipment. The O-ring K includes, for example, those having a glossy mirror-finished surface with small surface roughness. The O-ring appearance inspection apparatus of the present invention can particularly suitably perform appearance inspection on an O-ring having a mirror-finished surface. In this specification, an O-ring with a mirror-finished surface may simply be referred to as a “mirror-finished O-ring”. The mirror-finished O-ring may have an arithmetic mean roughness (Ra) of 0.2 μm or less and a maximum height roughness (Rz) of 1.0 μm or less, for example, in surface roughness measurement conducted according to JIS B 0601:2013. The O-ring may have Ra of 0.1 μm or less and Rz of 0.5 μm or less. However, the measurement conditions shall be a cut-off value λc of 0.8 mm and an evaluation length of 5 λc.

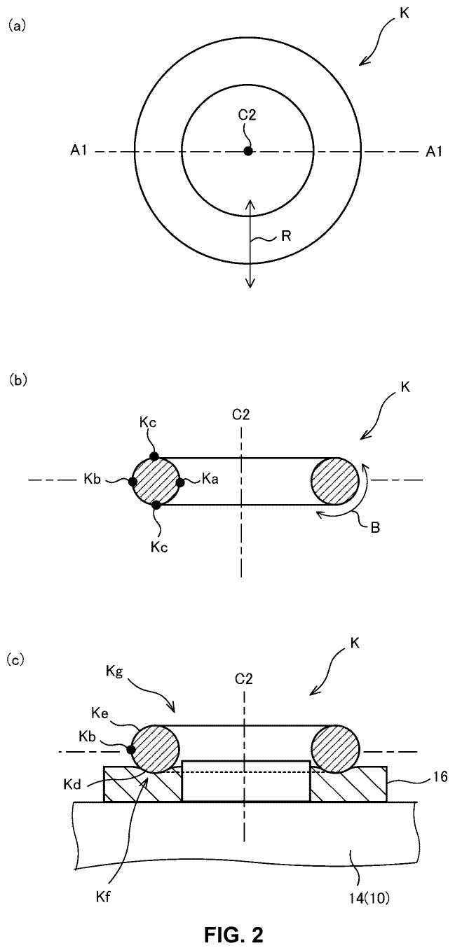

As shown in FIG. 2(a), the O-ring K has an annular appearance in plan view. Further, as shown in FIG. 2(b), the O-ring K has a cross-sectional shape such as a circular shape (including a true circle) or an elliptical shape. Further, the cross-sectional shape of the O-ring K is not particularly limited, and examples include a rectangular shape, an X-shape, a D-shape (semi-circular shape), a V-shape, an H-shape, a U-shape, a T-shape, an L-shape, and the like. That is, a curved surface is formed on the surface of the O-ring K.

In the present specification, a line passing through the center in a plan view of the O-ring K is referred to as a “central axis C2”. The central axis C2 can be regarded as a centerline when the O-ring K is rotated in a circumferential direction. In the present specification, the radial direction of the O-ring K is simply referred to as “radial direction R”. In the present specification, an end portion in the central axis C2 direction of the O-ring K is referred to as “top Kc”, an inner end in the radial direction R is referred to as “inner end Ka”, and an outer end in the radial direction R is referred to as “outer end Kb”. In the present specification, the circumferential direction of the cross section of the O-ring K in a cross-sectional view obtained by cutting the O-ring K along a section including the central axis C2 (the A1-A1 section in FIG. 2(a)) is referred to as “cross-sectional circumferential direction B”.

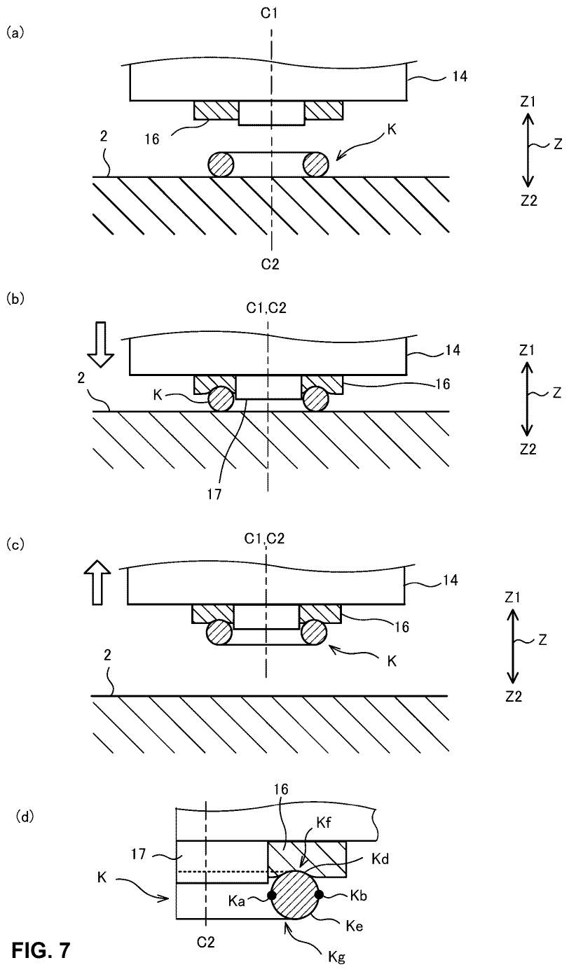

As will be described later, the O-ring K is held by a holding device 10 in tight contact with a tack surface body 16 (see FIG. 2(c), FIG. 7). In the present specification, in a state where the O-ring K is in tight contact with the tack surface body 16, a portion of the O-ring K that is in contact with the tack surface body 16 may be referred to as “contact portion Kd”. Further, in the present specification, in a state where the O-ring K is in tight contact with the tack surface body 16, a portion of the O-ring K that is not in contact with the tack surface body 16 (a portion other than the contact portion Kd) may be referred to as “exposed portion Ke”.

In the present specification, one portion of the entire O-ring K obtained when the O-ring K is divided by a virtual plane including the outer end Kb is referred to as “one half toroidal portion”. The one half toroidal portion can be regarded as one of the two sides of the O-ring K in the direction of the central axis C2. In the present specification, the two sides of the O-ring K in the direction of the central axis C2 are simply referred to as “both sides of the O-ring”.

In the present specification, one half toroidal portion of the O-ring K including a portion (contact portion Kd) that is in contact with the tack surface body 16 may be simply referred to as “contact side Kf”. Further, in the present specification, the other side of the O-ring K, which is different from the one half toroidal portion (contact side Kf) including the portion (contact portion Kd) that is in contact with the tack surface body 16, may be simply referred to as “exposed side Kg”.

In the following description, the up-down direction in the state where the O-ring appearance inspection apparatus 1 is installed is simply referred to as “up-down direction Z”. In the up-down direction Z, the upward direction is simply referred to as “upward Z1” and the downward direction is simply referred to as “downward Z2”.

In the following description, a direction orthogonal to the up-down direction Z (horizontal direction) is referred to as “lateral direction N”. The lateral direction N can be regarded as a horizontal direction orthogonal to the up-down direction Z when the O-ring appearance inspection apparatus 1 is installed, including the front-rear direction and the left-right direction of the O-ring appearance inspection apparatus 1.

As shown in FIG. 1, the O-ring appearance inspection apparatus 1 includes a holding device 10, a camera 20, an illumination device 30, and a control device 40.

The O-ring appearance inspection apparatus 1 image-captures the O-ring K at the image-capturing position P facing the camera 20. In the O-ring appearance inspection apparatus 1 of the present embodiment, the O-ring K is image-captured four times at different angles on one half toroidal portion. The O-ring appearance inspection apparatus 1 changes the posture (angle) of the O-ring K while holding the same with the holding device 10 and image-captures the O-ring K at each posture.

### Holding Device

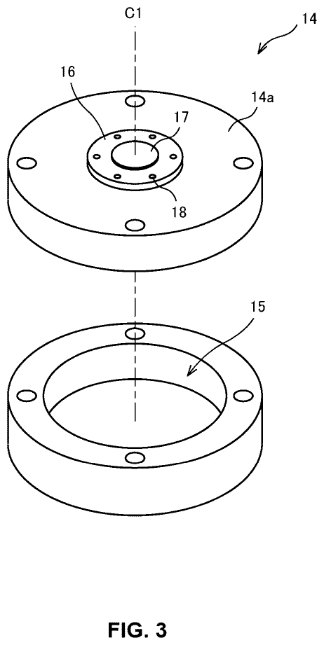

The holding device 10 holds the O-ring K and rotates the same in the circumferential direction. As shown in FIG. 1, the holding device 10 includes a base unit 11, an arm unit 12, and a head unit 14. Further, as shown in FIG. 3, the head unit 14 of the holding device 10 is provided with a tack surface body 16 and a positioning member 17.

The present embodiment illustrates an example in which a vertical multi-joint robot (so-called robot arm), having a plurality of arm units 12, is employed as the holding device 10. The holding device 10 is configured such that the arm unit 12 moves to place the head unit 14 at various positions and to maintain the head unit 14 at various angles.

Note that the holding device is not limited to a vertical multi-joint robot and may alternatively be a horizontal multi-joint robot (so-called SCARA robot: Selective Compliance Assembly Robot Arm) having multiple joints. The holding device may, for example, be selected from various moving devices capable of holding and moving the O-ring.

The head unit 14 is rotatable about a rotation axis C1. As shown in FIG. 3, the head unit 14 has a cylindrical appearance, and its interior is hollow. A not-shown negative pressure generator is connected to the head unit 14. This allows the head unit 14 to make its interior (negative pressure chamber 15) a negative pressure or a positive pressure. In other words, the holding device 10 has a negative pressure chamber 15 that generates a negative pressure.

In the present specification, regarding the orientation of the head unit 14, a state in which the distal end surface 14a faces down in the Z2 direction is referred to as “downward,” a state in which the distal end surface 14a is inclined with respect to the lateral direction N is referred to as “oblique,” and a state in which the distal end surface 14a is inclined with respect to the lateral direction N and is positioned lower in the Z2 direction than the other surface (proximal end surface 14b) of the head unit 14 is referred to as “obliquely downward”.

As shown in FIG. 3, the tack surface body 16 and the positioning member 17 are provided on the distal end surface 14a of the head unit 14. The positioning member 17 is configured such that, when the O-ring K is held on the tack surface body 16, its outer peripheral surface contacts at least a portion of the inner peripheral surface of the O-ring K.

The tack surface body 16 holds the O-ring K while keeping it in tight contact. The tack surface body 16 has physical tackiness. Specifically, the tack surface body 16 is made of a material that has physical tackiness resulting from its flexibility. The tack surface body 16 enhances its tight contact with the O-ring K through elastic deformation and is capable of holding the O-ring K in tight contact. That is, the tack surface body 16 is made of a material that can temporarily fix an object by keeping it in tight contact without using an adhesive.

The tack surface body may be a material having physical tackiness. For example, the tack surface body may be a material containing, as a main component, at least one resin selected from among a silicone-based resin, an acrylic-based resin, and a rubber-based adhesive resin. The tack surface body may be a silicone rubber, for example. By adopting a material that contains, as a main component, at least one resin selected from among a silicone-based resin, an acrylic-based resin, and a rubber-based adhesive resin as the tack surface body, the flexibility of the tack surface body can be enhanced, allowing for a more reliable tight contact of the O-ring K.

Note that traditionally known resins can be adopted as the silicone-based resin, the acrylic-based resin, and the rubber-based adhesive resin. The rubber-based adhesive resin is, for example, a thermoplastic elastomer. Among these, a silicone-based resin is more preferable from the viewpoint of suppressing glue residue while exhibiting relatively high tackiness. Further, examples of the tack surface body also include a biomimetic adhesive structure, a microfiber structure, a fine micro-patterned structure with uneven surface, a micro-suction structure, and the like.

Note that the tackiness herein refers to temporary and reversible tackiness. The tack surface body preferably has only physical tackiness. However, the tack surface body may be such that the physical tackiness is dominant, or the tack surface body primarily exhibits physical tackiness. That is, the term “only physical tackiness” as used herein means either strictly “only physical tackiness” or substantially “only physical tackiness”. The tackiness may partially include chemical adhesiveness, as long as substantially no glue residue is generated.

The O-ring may be made of rubber or resin. The term “rubber or resin” as used herein encompasses not only materials having both rubber and resin properties, such as thermoplastic elastomers, but also composite materials containing both rubber and resin. The O-ring made of rubber or resin may be suitably held by the tack surface body so as not to cause positional misalignment during movement and rotation of the O-ring.

As shown in FIG. 3, the tack surface body 16 has a through hole (suction port 18) that communicates with the negative pressure chamber 15. The holding device 10 can generate a negative pressure at the suction port 18 while the O-ring K is in tight contact with the tack surface body 16 and positioned by the positioning member 17. Thus, the O-ring K is held on the distal end surface 14a of the head unit 14 by the tackiness of the tack surface body 16 and the suction force generated at the suction port 18. Further, the holding device 10 can remove the O-ring K that is in tight contact with the tack surface body 16 by discharging air from the negative pressure chamber 15 through the through hole (suction port 18).

As will be described in detail later, the holding device 10 changes the orientation of the head unit 14 at the image-capturing position P while holding the O-ring K. Further, the holding device 10 rotates the head unit 14 about the rotation axis C1 at each image-capturing position P to rotate the O-ring K in the circumferential direction.

### Camera

Next, the configuration of the camera 20 will be described. The camera 20 image-captures the O-ring K. In the O-ring appearance inspection apparatus 1 of the present embodiment, the camera 20 is a line sensor camera that image-captures line images while moving a target object and combines the captured line images into a single image. The camera 20 has a plurality of light receiving elements configured to detect green light, red light, and blue light, respectively. The camera 20 image-captures the surface of the O-ring K by means of a light receiving element detecting light reflected from the surface of the O-ring K at the image-capturing position P (for example, reflected from the inspection target portion S).

### Camera Position

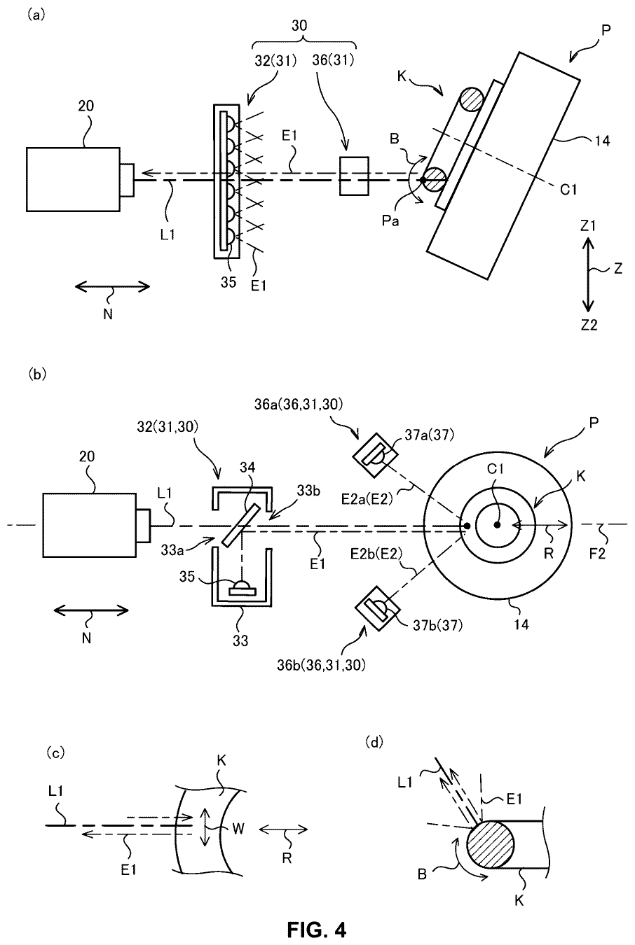

Next, the position of the camera 20 will be described with reference to FIG. 4. The position and orientation of the camera 20 are preset. That is, in the O-ring appearance inspection apparatus 1 of the present embodiment, the camera 20 is set in advance at a fixed position and orientation. In the O-ring appearance inspection apparatus 1 of this embodiment, the O-ring K is image-captured at a plurality of angles at the front of the camera 20 (image-capturing position P) while the O-ring K is held by the holding device 10 and the posture (angle) of the O-ring K is changed.

When the orientation of the camera 20 is set, the angle of the camera optical axis, which serve as the image-capturing center line of the camera 20, is also automatically determined. In the following description, the image-capturing center line of the camera 20 is referred to as the “camera optical axis L1”.

As shown in FIG. 4(a), the camera 20 in this embodiment is arranged in a horizontal orientation so that the camera optical axis L1 aligns with the lateral direction N.

As shown in FIG. 4(a), the camera 20 is arranged at a position farther from the first illumination unit 32 and the second illumination units 36 than the image-capturing position P. That is, the camera 20 is arranged at a position behind the first illumination unit 32 with respect to the O-ring K at the image-capturing position P, with the first illumination unit 32 interposed therebetween, which will be described later. In other words, the camera 20 is arranged at a position farther from the O-ring K at the image-capturing position P than the first illumination unit 32.

### Illumination Device

The illumination device 30 emits light toward the O-ring K at the image-capturing position P. As shown in FIG. 1, the O-ring appearance inspection apparatus 1 of the present embodiment is provided with one illumination device 30 corresponding to one camera 20.

The illumination device 30 includes at least one illumination unit 31 that emits light toward the O-ring K at the image-capturing position P. In the present embodiment, the illumination device 30 has a plurality of illumination units 31 (three in this embodiment). Specifically, as shown in FIG. 4(b), the illumination device 30 includes, as the illumination units 31, one first illumination unit 32 and two second illumination units 36.

As shown in FIG. 4(b), the first illumination unit 32 includes a housing 33, a half mirror 34, and light sources 35. The housing 33 includes a first opening 33a formed at a position facing the camera 20 and a second opening 33b formed at a position facing the first opening 33a. The first illumination unit 32 has a configuration in which the half mirror 34 and the light sources 35 are accommodated within the housing 33. The half mirror 34 is arranged at an angle of 45 degrees with respect to the illumination direction of the light emitted from the light sources 35. As shown in FIG. 4(b), the first illumination unit 32 reflects the first illumination light E1 by 90 degrees using the half mirror 34 and irradiates the O-ring K at the image-capturing position P with the reflected light from the second opening 33b. On the other hand, the light entering from the second opening 33b (the first illumination light E1 reflected from the surface of the O-ring K) passes through the half mirror 34, is emitted outward from the first opening 33a, and enters the camera 20.

As shown in FIG. 4(a), the first illumination unit 32 includes a plurality of light sources 35. In the present embodiment, the light sources 35 of the first illumination unit 32 are each an LED that emits green light. Accordingly, the first illumination light E1 emitted from the first illumination unit 32 is green light. In other words, the first illumination unit 32 emits the first illumination light E1 of green color.

As shown in FIG. 4(a), the first illumination unit 32 is arranged at a greater distance from the image-capturing position P than the second illumination units 36. That is, the first illumination unit 32 is arranged farther from the image-capturing position P than the second illumination units 36. Accordingly, as shown in FIG. 4(c), the first illumination light E1 that reaches the O-ring K at the image-capturing position P has a smaller angle of incidence in the width direction W, which intersects both the radial direction R and the central axis C2. Further, the camera 20 is configured as a line sensor camera. Therefore, the camera 20 image-captures a narrow band-shaped region in the width direction W of the O-ring K. Here, the surface of the mirror-finished O-ring K strongly exhibits the characteristic of specular reflection. Therefore, the first illumination light E1 emitted from the first illumination unit 32 toward the O-ring K enters the camera 20 while maintaining a high degree of parallelism with the camera optical axis L1.

Further, as described above, in the first illumination unit 32, a plurality of light sources 35 are arranged to form a row. As shown in FIG. 4(a), the plurality of light sources 35 are arranged to illuminate a portion in the cross-sectional circumferential direction B of the O-ring K. Specifically, as shown in FIG. 4(a), the plurality of light sources 35 are arranged along a direction that intersects the camera optical axis L1. Therefore, the first illumination light E1 enters the O-ring K at the image-capturing position P within a certain range in the cross-sectional circumferential direction B. In other words, the first illumination unit 32 emits the first illumination light E1 onto the O-ring K within a predetermined range according to its curved surface. Further, on the surface of the mirror-finished O-ring K, the incident light is reflected specularly according to the curved surface of the O-ring K. Therefore, as shown in FIG. 4(d), a portion of the first illumination light E1 emitted from the first illumination unit 32 toward the O-ring K is reflected so as to travel along the camera optical axis L1 and enters the camera 20.

Thus, the first illumination unit 32 is configured to emit light having a high degree of parallelism (light having high directivity) toward the O-ring K. Further, the first illumination unit 32 is configured to emit light (specularly reflected light) that is specularly reflected on the surface of the O-ring K.

Here, when the surface of the mirror-finished O-ring K is normal without scratches, scuffs, or other abnormalities, most of the light specularly reflected from the surface of the O-ring K enters the camera 20. On the other hand, when a defective portion such as a dent or a scratch exists on the surface of the O-ring K, the first illumination light E1 is diffusely reflected at the defective portion, and the diffusely reflected light from that portion does not enter the camera 20.

Such a phenomenon makes it possible to produce a difference between the amount of light reflected from the normal portion and entering the camera 20 and the amount of light reflected from the defective portion and entering the camera 20, even when the defect on the surface of the mirror-finished O-ring K, such as a shallow dent or scuff, is difficult to detect using diffused light. Further, in the O-ring appearance inspection apparatus 1, defective portions can be detected based on such differences in the amount of light. Therefore, the O-ring appearance inspection apparatus 1 can detect slight variation such as surface scuffing and shallow scratches. As a result, the O-ring appearance inspection apparatus 1 can further enhance inspection accuracy.

As shown in FIG. 4(b), the second illumination units 36 include light sources 37. As shown in FIG. 4(b), in this embodiment, two second illumination units 36 are provided for one first illumination unit 32. As shown in FIG. 4(b), the two second illumination units 36 are arranged symmetrically with respect to the camera optical axis L1 in a plan view. In other words, the two second illumination units 36 are arranged so as to be positioned on opposite sides of the camera optical axis L1. The second illumination units 36 each emits light having a color different from that of the first illumination unit 32. Specifically, among the two second illumination units 36, the light source 37a provided in one of the second illumination units 36a is an LED that emits blue light. The light source 37b provided in the other second illumination unit 36b is an LED that emits red light.

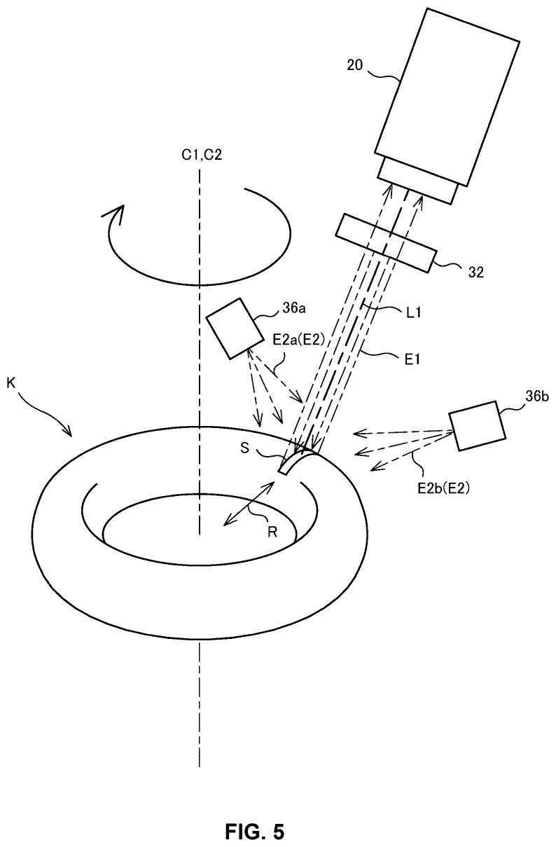

As shown in FIG. 4(a), the second illumination units 36 are arranged at a shorter distance from the image-capturing position P than the first illumination unit 32. That is, the second illumination units 36 are each arranged closer to the image-capturing position P than the first illumination unit 32. Therefore, the light (second illumination light E2) emitted from the second illumination units 36 is emitted so as to diffuse toward the O-ring K at the image-capturing position P (see FIG. 5). In other words, the second illumination units 36 each emits light having a low degree of parallelism (light having low directivity) toward the O-ring K, as compared with the first illumination unit 32. Further, the second illumination units 36 are each configured to emit light having a high degree of diffusion (diffused light).

Thus, the O-ring appearance inspection apparatus 1 of the present embodiment includes the first illumination unit 32 that emits light having a high degree of parallelism (specularly reflected light) toward the camera 20, and the second illumination units 36 that emit light having a low degree of parallelism (diffused light) toward the camera 20. In the O-ring appearance inspection apparatus 1, the illumination device 30 provided corresponding to the camera 20 includes the first illumination unit 32 that emits green light and the second illumination units 36 that emit light having a color different from that of the first illumination unit 32. Further, the first illumination unit 32 is arranged so that its distance from the image-capturing position P is greater than those of the second illumination units 36.

Here, when a defective portion such as a dent or a scratch exists on the O-ring K, its edge portion (wall portion) is illuminated by the second illumination light E2a and the second illumination light E2b, and the reflected light from the edge portion enters the camera 20. Thus, the O-ring appearance inspection apparatus 1 can detect abnormalities such as scratches or dents. Therefore, the O-ring appearance inspection apparatus 1 can simultaneously detect both ordinary scratches and slight variation such as surface scuffs and shallow scratches that cannot be detected by the light from the second illumination units 36.

### Control Device

The control device 40 controls the operation of the entire apparatus and determines whether the O-ring K is acceptable or defective based on the image captured by the camera 20. The control device 40 includes, as hardware components, a CPU (Central Processing Unit), a RAM (Random Access Memory), and a ROM (Read Only Memory), which are not shown. In such a hardware configuration, the CPU performs computations according to a predetermined program, and the control device 40 executes operations according to the loaded program.

The control device 40 includes functional units configured to execute various operations according to the program. For example, as shown in FIG. 1, the control device 40 includes an operation control unit 41 and a determination unit 42 as functional units. The operation control unit 41 controls the operations of respective components such as the holding device 10, the camera 20, and the illumination device 30. The determination unit 42 processes images of green light, red light, and blue light image-captured by the camera 20, and determines from the luminance levels whether defects such as dents or scratches are present on the O-ring K.

### Operation of O-Ring Appearance Inspection Apparatus

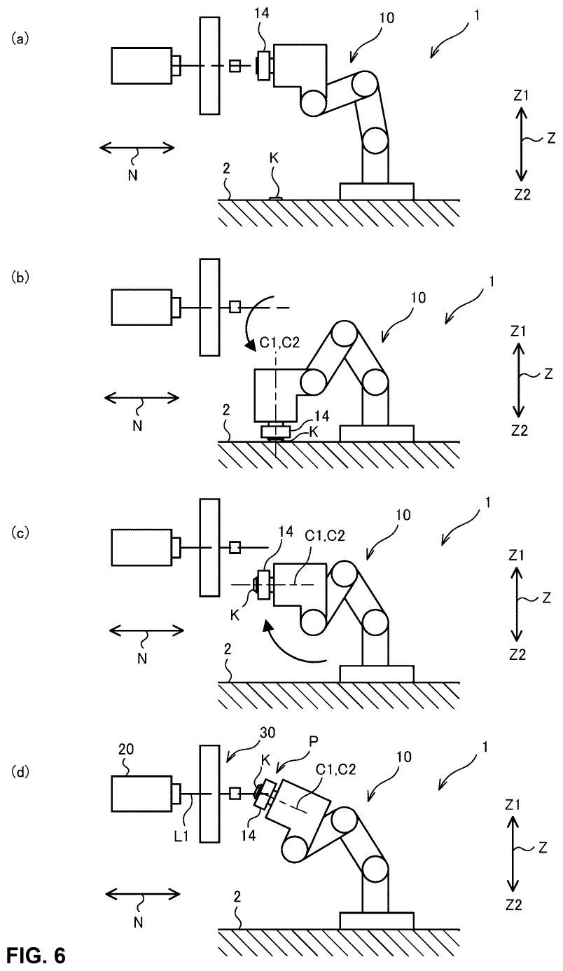

Next, the operation of the O-ring appearance inspection apparatus 1 will be described with reference to FIG. 6. The following operation of the O-ring appearance inspection apparatus 1 is performed under the control of the control device 40 (operation control unit 41). Further, the operation of the O-ring appearance inspection apparatus 1 described below can be said to correspond to each step of a method for performing an appearance inspection of the O-ring K (O-ring appearance inspection method).

As shown in FIG. 6(a) and FIG. 6(b), the O-ring appearance inspection apparatus 1 first operates the holding device 10 to move the head unit 14 downward in the Z2 direction toward the mounting surface 2 (mounting part), pick up the O-ring K placed on the mounting surface 2, and hold it with the head unit 14.

With reference to FIG. 7, the holding operation (holding step) of O-ring K will be described in more detail. As shown in FIG. 7(a), the O-ring appearance inspection apparatus 1 of the present embodiment moves the head unit 14 to a position upward Z1 to the O-ring K placed on the mounting surface 2, where the rotation axis C1 and the central axis C2 of the O-ring K coincide. A position identification camera (not shown) is provided in the head unit 14. The position of the central axis C2 of the O-ring is extracted by the position identification camera, and the head unit 14 is moved to a position where the rotation axis C1 and the central axis C2 are aligned.

The O-ring appearance inspection apparatus 1 relatively moves the mounting surface 2 with the O-ring K placed thereon and the head unit 14 closer to each other. Specifically, as shown in FIG. 7(b), the O-ring appearance inspection apparatus 1 moves the head unit 14 downward Z2 toward the mounting surface 2 at a position where the rotation axis C1 and the central axis C2 of the O-ring K are aligned. Further, the O-ring appearance inspection apparatus 1 brings the O-ring K into tight contact with the tack surface body 16 by pressing the head unit 14 against the O-ring K. As shown in FIG. 7(b), when the head unit 14 is pressed against the O-ring K, the tack surface body 16 is pressed between the head unit 14 and the O-ring K and elastically deforms, thus causing the tack surface body 16 to come into tight contact with the O-ring K. Further, the O-ring K is held by the head unit 14 through the tackiness of the tack surface body 16 and the negative pressure of the suction port 18 while being positioned by the positioning member 17.

As shown in FIG. 7(c), the O-ring appearance inspection apparatus 1 moves the head unit 14 upward Z1 while holding the O-ring K at the head unit 14 so that the rotation axis C1 and the central axis C2 align.

In this way, the O-ring appearance inspection apparatus 1 holds the O-ring K by using the head unit 14 to press it against the mounting surface 2 on which the O-ring K is placed, thereby bringing the O-ring K into tight contact with the tack surface body 16. Further, in the O-ring appearance inspection apparatus 1, the holding device 10 can hold the O-ring K while maintaining the shape of the O-ring K and the relative position with respect to the head unit 14, by allowing the tack surface body 16 to elastically deform and come into tight contact with the O-ring K.

Note that, while the O-ring appearance inspection apparatus 1 of the present embodiment is configured such that the tack surface body 16 is brought into tight contact with the O-ring K by bringing the head unit 14 close to the mounting surface 2, the O-ring appearance inspection apparatus of the present invention is not limited to this. For example, the O-ring appearance inspection apparatus of the present invention may be configured to maintain the position of the head unit 14 and bring the mounting surface 2 closer to the head unit 14, thereby bringing the tack surface body 16 into tight contact with the O-ring K. Further, the mounting part on which the O-ring is placed is not limited to a planar part (mounting surface). For example, the O-ring may be placed, before being held by the holding device, on a member having a protruding shape, a recessed shape, an uneven shape, or an undulating surface.

Here, as shown in FIG. 7(d), in a state where the O-ring K is held in tight contact with the tack surface body 16, the area (exposed area) of a portion of the O-ring K that is exposed without being in contact with the tack surface body 16 (exposed portion Ke) is greater than the area (contact area) of a portion of the O-ring K that is in contact with the tack surface body 16 (contact portion Kd). Further, while the O-ring K is held in tight contact with tack surface body 16, the exposed area is larger than the area of the contact side Kf of O-ring K (contact side area). In other words, the exposed surface of the O-ring K held by the tack surface body 16 is larger than the contact surface with the tack surface body 16, and also larger than the entire surface of the contact side Kf of the O-ring K.

More specifically, as shown in FIG. 7(d), the O-ring K is held by the holding device 10 in tight contact with the tack surface body 16, and both the inner end Ka and the outer end Kb are exposed without being covered by the tack surface body 16 or the positioning member 17. That is, in the O-ring appearance inspection apparatus 1, the contact side Kf of the O-ring K is brought into tight contact with the tack surface body 16 so that a portion of the contact side Kf is covered by the tack surface body 16, while the remaining portion including the inner end Ka and the outer end Kb is not covered by the tack surface body 16 and is exposed.

That is, in the O-ring appearance inspection apparatus 1, the O-ring K is held in such a manner that the O-ring K is brought into tight contact with the tack surface body 16 so as to ensure a larger exposed area of the O-ring K than the total area of one half toroidal portion (contact side Kf) of the O-ring K being held. In other words, in the O-ring appearance inspection apparatus 1, the O-ring K is held in such a manner that an area of the O-ring K covered by another member (for example, the tack surface body) is reduced.

Thus, when an appearance inspection is performed on one half toroidal portion of the O-ring K at a time, the O-ring appearance inspection apparatus 1 can partially overlap the inspection results, thereby enabling a highly accurate appearance inspection without leaving any portion uninspected.

Further, for example, when the O-ring is held by fitting the inner peripheral surface of the O-ring into a member having a protrusion shape, or by fitting the outer peripheral surface of the O-ring into a member having a recessed shape, the portion of the O-ring covered by the member inevitably becomes large when attempting to suppress positional misalignment of the O-ring. As a result, the inner end or the outer end of the O-ring is covered by the member, and when an appearance inspection is performed on one half toroidal portion of the O-ring at a time, it becomes difficult to overlap the inner end or the outer end in the inspection results on both sides.

In contrast, in the O-ring appearance inspection apparatus 1, the O-ring K is held in such a manner that the O-ring K is brought into tight contact with the tack surface body 16 so as to ensure a larger exposed area of the O-ring K than the total area of one half toroidal portion (contact side Kf) of the O-ring K being held, thereby allowing both the inner end Ka and the outer end Kb to be exposed. Therefore, the O-ring appearance inspection apparatus 1 can overlap the inner end Ka and outer end Kb in the inspection results on both sides. As a result, the O-ring appearance inspection apparatus 1 enables high-accuracy appearance inspection without leaving any portion uninspected.

The O-ring appearance inspection apparatus of the present invention may be configured such that the entire surface of the O-ring, except for the portion of the O-ring in contact with the tack surface body (contact portion), is exposed. For example, the O-ring appearance inspection apparatus of the present invention may not have a positioning unit. This makes it possible to expose the portion of the entire surface of the O-ring other than the portion in contact with the tack surface body (contact portion) and to further increase the exposed area.

In this way, the O-ring appearance inspection apparatus 1 can hold the O-ring K by bringing the O-ring K into tight contact with the tack surface body 16 through a simple operation of pressing the O-ring K against the mounting surface 2, thereby keeping the O-ring K from being deformed, scratched, or having foreign matter adhered thereto. In other words, the O-ring appearance inspection apparatus 1 can hold the O-ring K while suppressing a mechanical load applied to the O-ring K. Further, in the O-ring appearance inspection apparatus 1, since the O-ring K is held by the physical tackiness of the tack surface body 16, the holding state of the O-ring K can be maintained even when the posture of the O-ring K changes.

Further, since the tack surface body 16 can hold the O-ring K by contacting only a portion of one half toroidal portion of the O-ring K, a larger exposed area of the O-ring K can be secured. Further, the camera 20 is configured to image-capture at least the other side (exposed side Kg) different from the one half toroidal portion (contact side Kf) including the portion of the O-ring K that is in contact with the tack surface body 16. Therefore, the O-ring appearance inspection apparatus 1 ensures a large area of the O-ring K image-captured by the camera 20, enabling efficient image-capturing. Thus, according to the O-ring appearance inspection apparatus 1, the O-ring K can be held at an accurate position while ensuring a large exposed area regardless of individual differences of the O-ring K, thereby suppressing misalignment of an image-capturing target position when the O-ring K is rotated in the circumferential direction at the image-capturing position P and improving the accuracy and efficiency of the appearance inspection. As a result, the O-ring appearance inspection apparatus 1 can suppress deformation or scratches of the O-ring K and improve the accuracy of the appearance inspection.

As shown in FIG. 6(c), the O-ring appearance inspection apparatus 1 changes the orientation of the head unit 14 (in the direction of the rotation axis C1) while maintaining the position of the O-ring K relative to the head unit 14 after the O-ring K is held by the head unit 14. Note that, in the present embodiment, the head unit 14 changes its posture from a downward posture to a horizontal posture during the period from when the O-ring K is picked up from the mounting surface 2 until the O-ring K is positioned at the image-capturing position P, as shown in FIG. 6(b) to FIG. 6(d).

As shown in FIG. 6(d), after the head unit 14 holds the O-ring K, the O-ring appearance inspection apparatus 1 moves the head unit 14 to the image-capturing position P while holding the O-ring K in a state where the rotation axis C1 and the central axis C2 are aligned (moving step).

The O-ring appearance inspection apparatus 1 emits light toward the O-ring K by the first illumination unit 32 and the second illumination units 36 while maintaining the position and posture of the O-ring K at the image-capturing position P. Further, at the image-capturing position P, the O-ring appearance inspection apparatus 1 rotates the head unit 14 about the rotation axis C1 while maintaining the rotation axis C1 and the central axis C2 in alignment, and image-captures the O-ring K. Thus, light is emitted onto a portion of the O-ring K relative to a radial direction R (inspection target portion S), and the entire circumference of that portion is image-captured in the circumferential direction (image-capturing step).

As shown in FIG. 4(a), when the O-ring K is image-captured by the camera 20 (at the image-capturing position P), the head unit 14 is oriented and positioned such that the first illumination light E1 is specularly reflected at the image-capturing center position Pa of the O-ring K. As shown in FIG. 4(b), at the image-capturing position P, the head unit 14 is arranged at an orientation (angle) and position such that the camera optical axis L1 extends along a second virtual plane FIG. 2 including the rotation axis C1.

In the O-ring appearance inspection apparatus 1 of this embodiment, the orientation of the head unit 14 is changed to alter the posture of the O-ring K, and image-capturing is performed four times at different angles to image-capture one half toroidal portion of the O-ring K in a comprehensive manner. When the image-capturing at each angle is completed, the O-ring appearance inspection apparatus 1 discharges air from the suction port 18 to temporarily remove the O-ring K, inverts the O-ring K upside down, and image-captures the other side of the O-ring K in the same manner.

As described above, in the O-ring appearance inspection apparatus 1, the holding device 10 has a negative pressure chamber 15 in which a negative pressure is generated, and a suction port 18 (through hole) provided in the tack surface body 16 and communicating with the negative pressure chamber 15, and the O-ring K in tight contact with the tack surface body 16 is removed by discharging air from the negative pressure chamber 15 through the suction port 18.

Thus, in the O-ring appearance inspection apparatus 1, the O-ring K can be removed from the holding device 10 (head unit 14) without applying a load to the surface of the O-ring K, thereby further suppressing deformation or scratches of the O-ring K. As a result, the O-ring appearance inspection apparatus 1 can further suppress deformation or scratches of the O-ring K and improve the accuracy and efficiency of the appearance inspection.

The images captured by the camera 20 at each angle are transmitted to the control device 40, where the control device 40 (determination unit 42) processes the images and determines, based on the luminance level, whether defects such as dents or scratches are present on the O-ring K.

### Angle between Rotation Axis and Camera Optical Axis (Relative Angle)

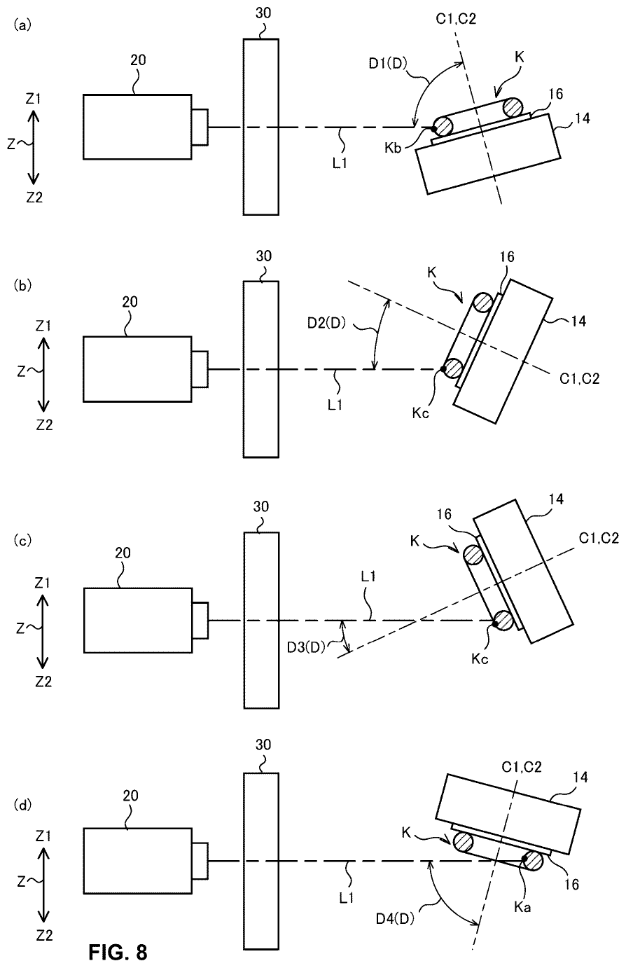

Next, the angle formed between the camera optical axis L1 and the rotation axis C1 (relative angle D) will be described with reference to FIG. 8.

As described above, in the O-ring appearance inspection apparatus 1 of this embodiment, the O-ring K is image-captured at a plurality of angles while the position of the O-ring K is maintained at the image-capturing position P and the posture (angle) of the O-ring K is changed. In the O-ring appearance inspection apparatus 1 of the present embodiment, the O-ring K is image-captured at each of four relative angles D. That is, the O-ring appearance inspection apparatus 1 image-captures the O-ring K from a plurality of angles by changing the relative angle between the camera optical axis L1 and the rotation axis C1 (central axis C2).

In the following description, the angle formed by the camera optical axis L1 and the rotation axis C1 (the relative angle of the camera optical axis L1 with respect to the rotation axis C1) is referred to as “relative angle D”. The relative angle D can be said to be the relative angle (posture) of the head unit 14 and the O-ring K with respect to the camera optical axis L1.

In the O-ring appearance inspection apparatus 1 of this embodiment, the orientation of the camera 20 is fixed, and by changing the posture of the head unit 14, the relative angle D is altered to image-capture the O-ring K from a plurality of angles.

The O-ring appearance inspection apparatus of the present invention is not limited to this embodiment. For example, the O-ring appearance inspection apparatus of the present invention may be configured to image-capture the O-ring at a plurality of relative angles by changing the angle of the camera 20 while maintaining the angle of the rotation axis C1. To further illustrate, the O-ring appearance inspection apparatus of the present invention may include a plurality of cameras having different angles, and the O-ring (head unit) may be moved or rotated while the posture of the O-ring (head unit) is maintained among these cameras.

In the O-ring appearance inspection apparatus 1 of the present embodiment, the O-ring K is image-captured four times on one half toroidal portion. That is, the O-ring appearance inspection apparatus 1 image-captures the O-ring K at four different relative angles D. Specifically, the O-ring appearance inspection apparatus 1 image-captures the O-ring K at four relative angles D: i.e., a first relative angle D1, a second relative angle D2, a third relative angle D3, and a fourth relative angle D4.

Note that the relative angle D described below is merely an example. Various relative angle D can be selected. The relative angle D can be appropriately set depending on, for example, the number of cameras 20, the size of the O-ring K, the number of times the O-ring K is image-captured on one half toroidal portion, and the like. Further, the number of times one half toroidal portion of the O-ring K is image-captured can be appropriately selected according to the relative angle or the like.

As shown in FIG. 8(a), at the first relative angle D1 (e.g., an angle at which the rotation axis C1 is 75 degrees clockwise (i.e., +75 degrees) with respect to the camera optical axis L1 in a front view), the head unit 14 is in a posture that allows the camera 20 to image-capture an area including the outer end Kb of the O-ring K. As shown in FIG. 8(a), at the first relative angle D1, the head unit 14 is in a diagonally upward posture.

As shown in FIG. 8(b), at the second relative angle D2 (e.g., an angle at which the rotation axis C1 is 25 degrees clockwise (i.e., +25 degrees) with respect to the camera optical axis L1 in a front view), the head unit 14 is in a posture that allows the camera 20 to image-capture an area including the top Kc of the O-ring K and a range closer to the outer peripheral surface. As shown in FIG. 8(b), at the second relative angle D2, the head unit 14 is in a nearly horizontal posture.

As shown in FIG. 8(c), at the third relative angle D3 (e.g., an angle at which the rotation axis C1 is 25 degrees counterclockwise (i.e., −25 degrees) with respect to the camera optical axis L1 in a front view), the head unit 14 is in a posture that allows the camera 20 to image-capture an area including the top Kc of the O-ring K and a range closer to the inner peripheral surface. As shown in FIG. 8(c), at the third relative angle D3, the head unit 14 is in a nearly horizontal posture.

As shown in FIG. 8(d), at the fourth relative angle D4 (e.g., an angle at which the rotation axis C1 is 75 degrees counterclockwise (i.e., −75 degrees) with respect to the camera optical axis L1 in a front view), the head unit 14 is in a posture that allows the camera 20 to image-capture an area including the inner end Ka of the O-ring K and the inner peripheral surface. As shown in FIG. 8(d), at the fourth relative angle D4, the head unit 14 is in an obliquely downward posture.

As described above, in the O-ring appearance inspection apparatus 1, it may be necessary to hold the O-ring K at various angles in order to inspect the O-ring K without leaving any portion uninspected. Specifically, as shown in FIG. 8, the head unit 14 may be in various orientations, such as an oblique orientation, a downward orientation, or a horizontal orientation. Here, when the O-ring K is in an oblique, downward, or horizontal posture, there is a concern that the O-ring K may fall from the head unit 14 or that its position may shift.

To address this, in the O-ring appearance inspection apparatus 1, the holding device 10 holds the O-ring K by the tackiness of the tack surface body 16 while the head unit 14 is in an oblique or downward orientation during both the movement operation of the O-ring K to the image-capturing position P and the rotation operation of the head unit 14.

According to the O-ring appearance inspection apparatus 1, the O-ring K can be held by the tackiness of the tack surface body 16 even when the head unit 14 is in a posture, such as an obliquely downward or downward posture, that raises concerns about dropping or positional deviation of the O-ring K during appearance inspection of the O-ring K. This enables suppression of the load applied to the O-ring K and also suppression of dropping or positional misalignment of the O-ring K. Therefore, according to the O-ring appearance inspection apparatus 1, a decrease in inspection efficiency caused by the O-ring K falling can be suppressed. As a result, the O-ring appearance inspection apparatus 1 can suppress the occurrence of deformation or scratches of the O-ring K, improve the accuracy of the appearance inspection, and also suppress the decrease in inspection efficiency.

Since the tack surface body can hold the O-ring K in an aspect suitable for inspection as described above, it is possible to suppress positional misalignment of the O-ring K caused by the gravitational force when the O-ring K is held in an oblique or downward orientation. The concept of positional misalignment also includes falling off. Therefore, falling off can also be suppressed. The O-ring K may be moved while being held in an oblique or downward orientation. In this case, the O-ring K is subjected to gravitational force and inertial force, but the tack surface body can suppress positional misalignment of the O-ring K. The O-ring K may be rotated while being held in an oblique or downward orientation. In this case, the O-ring K is subjected to gravitational force and centrifugal force, but the tack surface body can suppress positional misalignment of the O-ring K. As described above, the tack surface body can suppress positional misalignment of the O-ring K even in situations where a combination of forces is applied to the O-ring K.

### Inspection Target Portion at Each Relative Angle

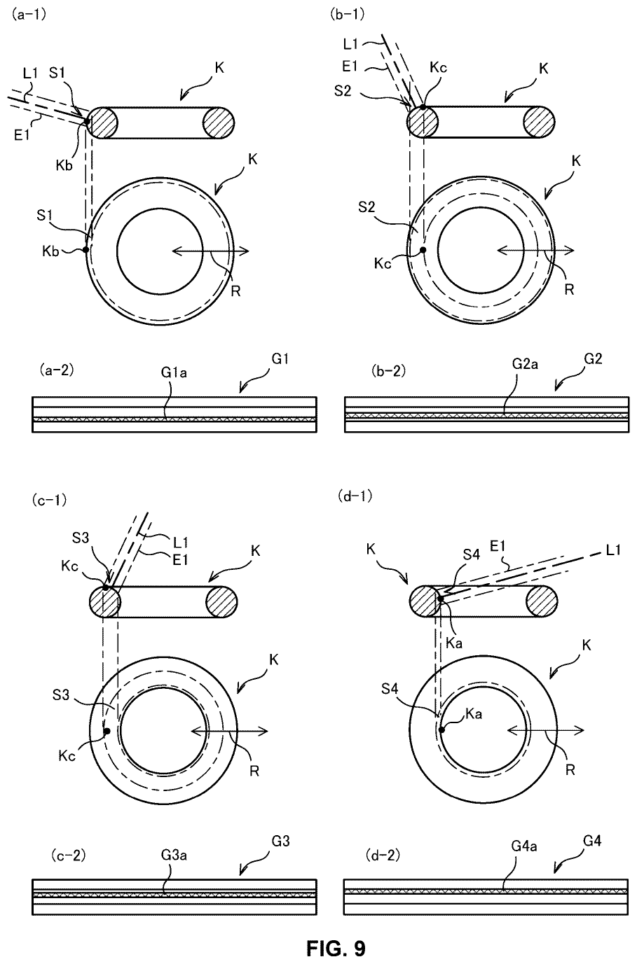

Next, with reference to FIG. 9, the inspection target portion S at each relative angle D will be described.

In the O-ring appearance inspection apparatus 1, different portions of the O-ring K in the radial direction R are image-captured at a plurality of relative angles D while changing the posture of the A. Thus, in the O-ring appearance inspection apparatus 1, one half toroidal portion of the O-ring K can be inspected without leaving any portion uninspected.

As described above, the O-ring appearance inspection apparatus 1 is configured that at least a part of the light from the first illumination unit 32 is specularly reflected on the surface of the O-ring K so that the reflected light enters the camera 20. In the O-ring appearance inspection apparatus 1, a slight variation in the O-ring K can be detected by causing the light from the first illumination unit 32 to enter the camera 20 along the camera optical axis L1 (by causing specularly reflected light to enter).

Therefore, as shown in FIG. 5, the portion of the O-ring K that reflects the first illumination light E1 as specularly reflected light (light having a high degree of parallelism) can be regarded as the portion to be inspected in the O-ring appearance inspection apparatus 1. From a reverse point of view, the inspection target portion can be regarded as the portion that specularly reflects the light of the first illumination light E1 toward the camera 20. In the following description, the portion of the O-ring K that reflects the first illumination light E1 as specularly reflected light (light having a high degree of parallelism) is referred to as “inspection target portion S”.

Further, the inspection target portion S at the first relative angle D1 is referred to as “first inspection target portion S1”, the inspection target portion S at the second relative angle D2 is referred to as “second inspection target portion S2”, the inspection target portion S at the third relative angle D3 is referred to as “third inspection target portion S3”, and the inspection target portion S at the fourth relative angle D4 is referred to as “fourth inspection target portion S4”.

As mentioned above, at the first relative angle D1, a portion of the outer peripheral surface including the outer end Kb in the radial direction R of the O-ring K is image-captured (see FIG. 8(a)). Further, as shown in FIG. 9(a-1), the first illumination light E1 that is specularly reflected at a portion of the outer peripheral surface including the outer end Kb enters the camera 20 along the camera optical axis L1. Therefore, of the O-ring K, the portion of the outer peripheral surface including the outer end Kb can be regarded as the first inspection target portion S1 that reflects the light of the first illumination light E1 toward the camera 20 along the camera optical axis L1 at the first relative angle D1.

The O-ring appearance inspection apparatus 1 maintains the posture of the head unit 14 at the first relative angle D1 and, while emitting the first illumination light E1 onto the first inspection target portion S1 and rotating the head unit 14, image-captures the O-ring K with the camera 20 so as to include the entire circumference of the first inspection target portion S1 in the circumferential direction. Further, as shown in FIG. 9(a-2), the O-ring appearance inspection apparatus 1 obtains, as an image-capturing result, a first image G1 including an image of the entire circumference of the first inspection target portion S1 (first illuminated image portion G1a), to which light having a high degree of parallelism is emitted by the image-capturing of the camera 20, in the circumferential direction.

As mentioned above, at the second relative angle D2, a portion of the outer peripheral surface closer to the top Kc in the radial direction R of the O-ring K is image-captured (see FIG. 8(b)). Further, as shown in FIG. 9(b-1), the first illumination light E1 that is specularly reflected at a portion of the outer peripheral surface including the top Kc enters the camera 20 along the camera optical axis L1. Therefore, of the O-ring K, the portion of the outer peripheral surface including the top Kc can be regarded as the second inspection target portion S2 that reflects the light of the first illumination light E1 toward the camera 20 along the camera optical axis L1 at the second relative angle D2.

The O-ring appearance inspection apparatus 1 maintains the posture of the head unit 14 at the second relative angle D2 and, while emitting the first illumination light E1 onto the second inspection target portion S2 and rotating the head unit 14, image-captures the O-ring K with the camera 20 so as to include the entire circumference of the second inspection target portion S2 in the circumferential direction. Further, as shown in FIG. 9(b-2), the O-ring appearance inspection apparatus 1 obtains, as an image-capturing result, a second image G2 including an image of the entire circumference of the second inspection target portion S2 (second illuminated image portion G2a), to which light having a high degree of parallelism is emitted by the image-capturing of the camera 20, in the circumferential direction.

As mentioned above, at the third relative angle D3, a portion of the inner peripheral surface closer to the top Kc in the radial direction R of the O-ring K is image-captured (see FIG. 8(c)). Further, as shown in FIG. 9(c-1), the first illumination light E1 that is specularly reflected at a portion of the inner peripheral surface including the top Kc enters the camera 20 along the camera optical axis L1. Therefore, of the O-ring K, the portion of the inner peripheral surface including the top Kc can be regarded as the third inspection target portion S3 that reflects the light of the first illumination light E1 toward the camera 20 along the camera optical axis L1 at the third relative angle D3.

The O-ring appearance inspection apparatus 1 maintains the posture of the head unit 14 at the third relative angle D3 and, while emitting the first illumination light E1 onto the third inspection target portion S3 and rotating the head unit 14, image-captures the O-ring K with the camera 20 so as to include the entire circumference of the third inspection target portion S3 in the circumferential direction. Further, as shown in FIG. 9(c-2), the O-ring appearance inspection apparatus 1 obtains, as an image-capturing result, a third image G3 including an image of the entire circumference of the third inspection target portion S3 (third illuminated image portion G3a), to which light having a high degree of parallelism is emitted by the image-capturing of the camera 20, in the circumferential direction.

As mentioned above, at the fourth relative angle D4, a portion of the inner peripheral surface including the inner end Ka in the radial direction R of the O-ring K is image-captured (see FIG. 8(d)). Further, as shown in FIG. 9(d-1), the first illumination light E1 that is specularly reflected at a portion of the inner peripheral surface including the inner end Ka enters the camera 20 along the camera optical axis L1. Therefore, of the O-ring K, the portion of the inner peripheral surface including the inner end Ka can be regarded as the fourth inspection target portion S4 that reflects the light of the first illumination light E1 toward the camera 20 along the camera optical axis L1 at the fourth relative angle D4.

The O-ring appearance inspection apparatus 1 maintains the posture of the head unit 14 at the fourth relative angle D4 and, while emitting the first illumination light E1 onto the fourth inspection target portion S4 and rotating the head unit 14, image-captures the O-ring K with the camera 20 so as to include the entire circumference of the fourth inspection target portion S4 in the circumferential direction. Further, as shown in FIG. 9(d-2), the O-ring appearance inspection apparatus 1 obtains, as an image-capturing result, a fourth image G4 including an image of the entire circumference of the fourth inspection target portion S4 (fourth illuminated image portion G4a), to which light having a high degree of parallelism is emitted by the image-capturing of the camera 20, in the circumferential direction.

Thus, in the O-ring appearance inspection apparatus 1, a portion (inspection target portion S) in the radial direction R of the O-ring K, which rotates in the circumferential direction at the image-capturing position P, is image-captured over the entire circumference in the circumferential direction, and the image-capturing results based on the four patterns of relative angles D are configured to include the entire area of one half toroidal portion of the O-ring K. Further, the four image-capturing results include images (images of the inspection target portions S) of portions where specularly reflected light (light having a high degree of parallelism) is reflected, covering the entire area of one half toroidal portion of the O-ring K. Thus, in the O-ring appearance inspection apparatus 1, one half toroidal portion of the O-ring K can be inspected with high accuracy and without leaving any portion uninspected.

Further, as described above, in the O-ring appearance inspection apparatus 1, the O-ring K is held while ensuring a large exposed area of the O-ring K so that both the inner end Ka and the outer end Kb are exposed by keeping the O-ring K in tight contact with the tack surface body 16. Therefore, the O-ring appearance inspection apparatus 1 can overlap the inner end Ka and outer end Kb in the inspection results on both sides. As a result, the O-ring appearance inspection apparatus 1 enables high-accuracy appearance inspection without leaving any portion uninspected.

Although the embodiments of the O-ring appearance inspection apparatus of the present invention have been described above, the O-ring appearance inspection apparatus of the present invention is not limited to the embodiments described above.

In the embodiments described above, an example is shown in which a single camera 20 is provided, and by changing the orientation of the head unit 14 in front of that camera 20, the O-ring K is image-captured from a plurality of angles; however, the O-ring appearance inspection apparatus of the present invention is not limited to the embodiments described above.

For example, as described above, the O-ring appearance inspection apparatus of the present invention may include a plurality of cameras. Further, with the plurality of cameras, the illumination devices may be provided for each of the cameras, respectively.

In the above embodiment, an example was shown where the angle of the head unit 14 was changed to image-capture the O-ring K, but the orientation of the head unit may be the same. For example, the head unit may be maintained in a downward orientation after picking up the O-ring, including during image-capturing by the imaging device and during movement between image-capturing positions.

In the embodiments described above, although an example is shown in which one half toroidal portion of the O-ring K is image-captured four times so as to cover one half toroidal portion of the O-ring K, the apparatus may be configured to perform image-capturing three times on one half toroidal portion of the O-ring, or five or more times of image-capturing.

In the embodiments described above, although an example is shown in which second illumination units 36 are provided in addition to the first illumination unit 32, a configuration without the second illumination unit may also be employed. Also, in the embodiments described above, although an example is shown in which the second illumination unit emits diffused light, the second illumination unit may be configured to emit light having a high degree of parallelism. Further, in the embodiments described above, although an example is shown in which the first illumination unit 32 emits green light and the second illumination units 36 emit red light and blue light, the colors of the light emitted from the first and second illumination units are not limited to the embodiments described above, and the colors of the light from the first and second illumination units can be appropriately selected.

While one embodiment of the present invention has been described above, the specific aspects that the invention can take are not limited to the embodiment described above.

### LISTING OF REFERENCE CHARACTERS

1 O-Ring Appearance Inspection Apparatus
2 Mounting Surface (Mounting part)
10 Holding Device
12 Arm Unit
14 Head Unit
14a Distal End Surface
15 Negative Pressure Chamber
16 Tack Surface Body
18 Suction Port (Through Hole)
20 Camera
C1 Rotation Axis
C2 Central Axis
P Image-capturing position

1. An O-ring appearance inspection apparatus that performs an appearance inspection of an O-ring, comprising:
a holding device having a head unit rotatable about a rotation axis and a tack surface body having physical tackiness, which is provided on the head unit, the holding device configured to hold the O-ring and rotate it in a circumferential direction; and
a camera configured to image-capture the O-ring,
wherein: the O-ring is held by bringing the head unit and a mounting part on which the O-ring is placed closer to each other, thereby pressing the O-ring against the tack surface body and bringing the O-ring into tight contact with the tack surface body; the O-ring, being held, is moved to an image-capturing position facing the camera; and the O-ring is image-captured by the camera while being rotated in its circumferential direction by rotating the head unit about its rotation axis at the image-capturing position.

2. The O-ring appearance inspection apparatus according to claim 1, wherein the holding device is configured to hold the O-ring while maintaining the shape of the O-ring and the relative position of the O-ring with respect to the head unit, by allowing the tack surface body to elastically deform so that it is in tight contact with the O-ring.

3. The O-ring appearance inspection apparatus according to claim 1, wherein the tack surface body contains, as a main component, at least one resin selected from among a silicone-based resin, an acrylic-based resin, and a rubber-based adhesive resin.

4. The O-ring appearance inspection apparatus according to claim 1, wherein the holding device holds the O-ring by the tackiness of the tack surface body in a state where the head unit is oriented obliquely or downward during at least part of the operations including the movement operation to the image-capturing position of the O-ring and the rotation operation of the head unit.

5. The O-ring appearance inspection apparatus of claim 1, wherein:
the holding device
comprises a negative pressure chamber in which a negative pressure is generated, and a through hole provided in the tack surface body and in communication with the negative pressure chamber; and
removes the O-ring that is in tight contact with the tack surface body by discharging air from the negative pressure chamber via the through hole.

6. An O-ring appearance inspection method using an O-ring appearance inspection apparatus comprising a holding device configured to hold an O-ring and a camera configured to image-capture the O-ring, wherein:
the holding device comprises a head unit rotatable about its rotation axis and a tack surface body having physical tackiness, which is provided on the head unit; and
the O-ring is held by bringing the head unit and a mounting part on which the O-ring is placed closer to each other, thereby pressing the O-ring against the tack surface body and bringing the O-ring into tight contact with the tack surface body, the O-ring, being held, is moved to an image-capturing position facing the camera, and the O-ring is image-captured by the camera while being rotated in its circumferential direction by rotating the head unit about its rotation axis at the image-capturing position.
